(19) United States
(12) Patent Application Publication
(10) Pub. No.: US 2017/0244873 A1
(43) Pub. Date: Aug. 24, 2017

(54) DEVICE FOR RECORDING IMAGES OF A ROAD SCENE FOR A MOTOR VEHICLE

(71) Applicant: Valeo Systèmes d'Essuyage, Le Mesnil Saint Denis (FR)

(72) Inventors: Vincent Izabel, Le Mesnil Saint Denis (FR); Jean-François Rousseau, Issoire (FR)

(73) Assignee: Valeo Systèmes d'Essuyage, Le Mesnil Saint Denis (FR)

(21) Appl. No.: 15/517,750

(22) PCT Filed: Oct. 7, 2015
(86) PCT No.: PCT/EP2015/073081

§ 371 Date: Apr. 7, 2017

(30) Foreign Application Priority Data
Oct. 16, 2014 (FR) 1459924

(51) Int. Cl. H04N 5/225; G02B 27/00; H04N 7/18; B60S 1/56; B60S 1/04

(52) U.S. Cl. CPC H04N 5/2252; B60S 1/56; B60S 1/04; H04N 7/183; G02B 27/0006

(57) ABSTRACT

According to the invention, the device for recording images (1) of a road scene for a motor vehicle comprises at least one camera (2) defining an optical axis, a protective element (4) for protecting the camera and cleaning means (8) for cleaning this screen. The protective element surrounds the camera and is mounted movable in rotation about said camera, comprising at least two separate portions each capable of assuming an image capturing position (16; 116) opposite the camera under the effect of the rotation. At least one of the separate portions is a light-transparent screen (18; 118) for being disposed in the image capturing position when the camera is operating, and the cleaning means (8) are disposed on the passage of the movable protective element in order to clean the transparent screen.

The invention relates to the field of assistance with driving and notably to video cameras installed on some motor vehicles. The invention relates more particularly to a road scene imaging device and to the means employed to ensure optimum quality of the driving assistance information supplied to the driver.

Some motor vehicles are now equipped with imaging means, and particularly with video cameras, in particular to assist the driver when parking and/or reversing. The information supplied to the driver is more useful if the image acquired by the imaging means is sharp.

Whatever the final purpose of a rear view device of this kind, the video camera is usually and extremely logically installed in the rear part of the vehicle.

Thus it may be integrated directly into the bodywork or into any component of the rear part of the vehicle, such as a bumper, a spoiler, a hatchback, etc., for example. The video camera is moreover generally mounted in a fixed manner since its position as previously referred to is perfectly appropriate to its function. The video camera is commonly installed so that the end of the lens system or the protective screen is substantially flush with its supporting element. The closeness of the video camera to the outside renders it particularly sensitive to deposited dirt, which can compromise the quality of the image acquired by the video camera.

The document WO 2005/021329 describes a mobile protection flap moving between a closed position and an open position in which the flap is respectively disposed in front of and away from the lens of the video camera. The mobile protective flap is an attached part and can add to the overall size, depending on the complexity of the drive mechanism, and its only function is creating an opaque screen when the video camera is not operating. An arrangement of this kind makes it possible to protect the lens, notably from dirt, when the video camera is not performing its imaging function. Note that dirt may be deposited on the lens when the camera is active and the flap is in the open position, however.

The present invention is part of this context and has the objective of proposing a road scene imaging device that is particularly effective, i.e. that enables the acquisition of images with a quality that can easily be processed by the onboard electronics of the vehicle for its optimum presentation to the driver. To this end, the invention consists in an imaging device that includes at least one video camera defining an optical axis, an element for protecting the video camera that surrounds the latter, and cleaning means. The protection element is mounted to be mobile in rotation around the video camera and includes at least two separate parts each adapted to adopt an imaging position in front of the video camera by virtue of the rotation, at least one of the separate parts being a screen transparent to light adapted to be disposed in the imaging position when the video camera is operating. The cleaning means are adapted to clean the transparent part as the mobile protection element passes them.

By “downstream of the lens” is meant a position in which the mobile protection element on the optical axis and downstream of the video camera is disposed between the video camera and the road scene that the video camera can image.

Having a protection element around the video camera makes it possible to ensure that no dirt impacts directly on the lens of the video camera, the latter being always set back from the protection element. This is advantageously combined with rotation of the protection element and an appropriate arrangement of the cleaning means on the path of said protection element to ensure that the part of the mobile protection element that is moved in front of the lens of the video camera when an imaging function is requested is clean.

According to features specific to different embodiments of the invention, the mobile protection element may be formed by a cylinder made from a material that is entirely transparent to light, possibly polycarbonate, or the mobile protection element may include, in addition to the transparent screen, an opaque masking zone.

The protection element is advantageously mounted to be mobile in rotation about an axis perpendicular to the optical axis.

According to features specific to different embodiments of the invention, the means for driving the protection element in rotation may include a non-reversible motor or a reversible motor driving the protection element in rotation in one direction and then the other between two extreme positions one of which corresponds to the imaging position in front of the video camera.

The cleaning means are disposed in a fixed manner relative to the video camera, on the path of the protection element when it moves.

According to various features specific to said cleaning means, separately or in combination:
they may include a sprayer element adapted to spray cleaning liquid onto the transparent screen in a cleaning area and a wiper element for wiping said transparent screen;
the sprayer element is disposed upstream of the wiper element relative to the direction of rotation of the mobile protection element;
the cleaning means are carried by an additional casing and the sprayer element consists in spray nozzles carried by an arm fastened to the casing that extends parallel to the rotation axis of the cylinder;
the cleaning means further include at least one heating element disposed in the vicinity of the mobile protection element;
the cleaning means are mounted on the internal face of a structural element of the vehicle;
the wiper element is mounted on a part of the removable structural element and accessible from the outside of the vehicle.

Said cleaning means may further include at least one heating element.

The invention also concerns a method of imaging a road scene in a motor vehicle in which the rotation of a mobile protection element disposed around an imaging video camera is controlled so as, when an imaging function is required, to bring a part of the protection element forming a transparent screen into an imaging zone facing the video camera and in which the triggering of a cleaning function is commanded when the mobile protection element moves through a cleaning area during said rotation of the protection element.

According to distinct features that depend on the embodiment of the invention, the triggering of a cleaning function may take place before or after imaging.

Other features and advantages of the present invention will become more clearly apparent in the light of the description and the drawings, in which:

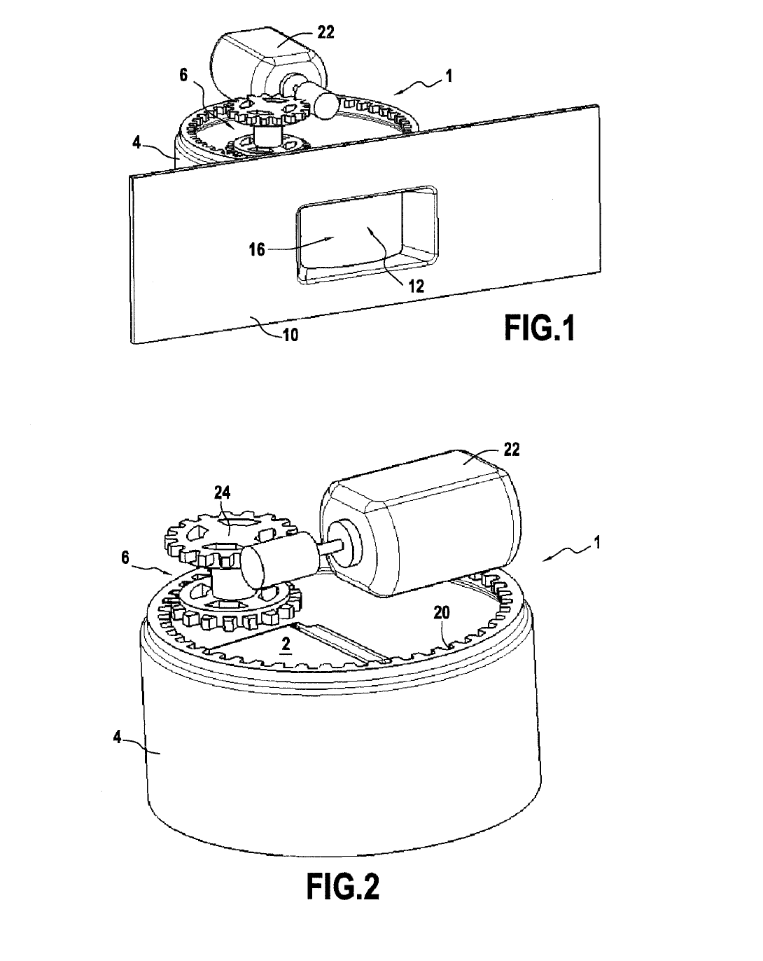

FIG. 1 is a perspective view, as seen from outside the vehicle, of an imaging device according to a first embodiment set back behind a bodywork element including at least one video camera surrounded by a protection element, the lens of the video camera being made visible via an orifice in the bodywork;

FIG. 2 is a perspective side view of elements of the imaging device from FIG. 1, including a video camera, a mobile protection element, and means for driving said mobile protection element in rotation;

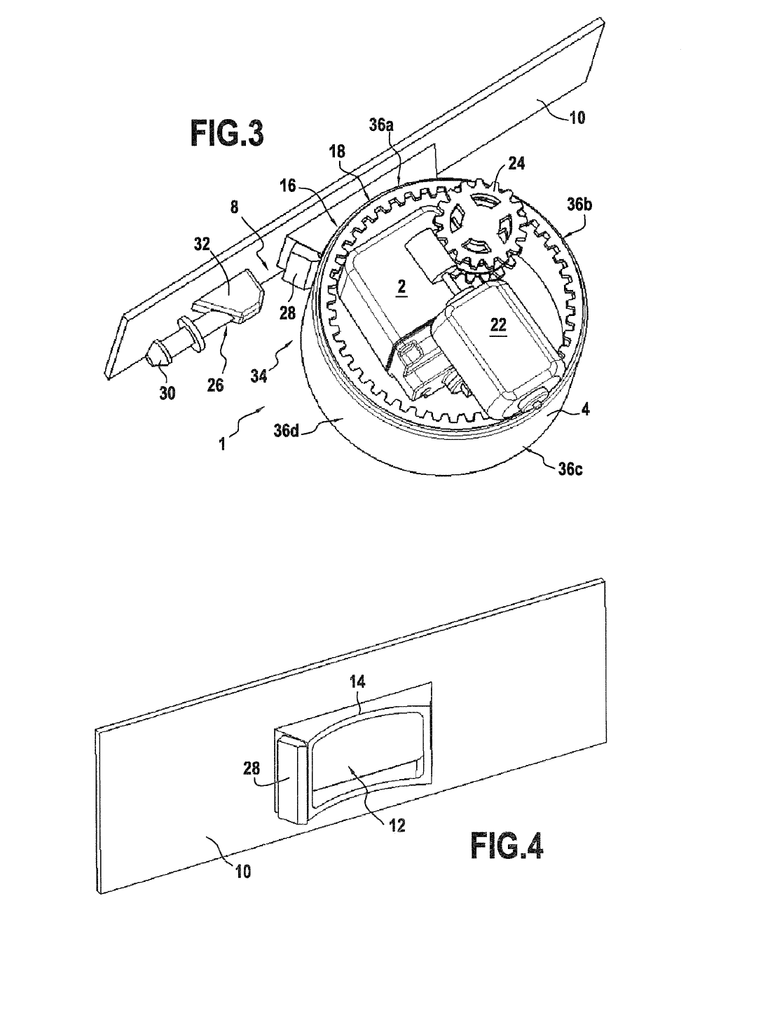

FIG. 3 is a perspective top view of the imaging device as a whole, including the elements from FIG. 2 together with a wiper element and a sprayer element that are fixed to a bodywork element;

FIG. 4 is a perspective view as seen from inside the vehicle of a detail of the bodywork element adapted to receive in particular the wiper element shown in FIG. 3;

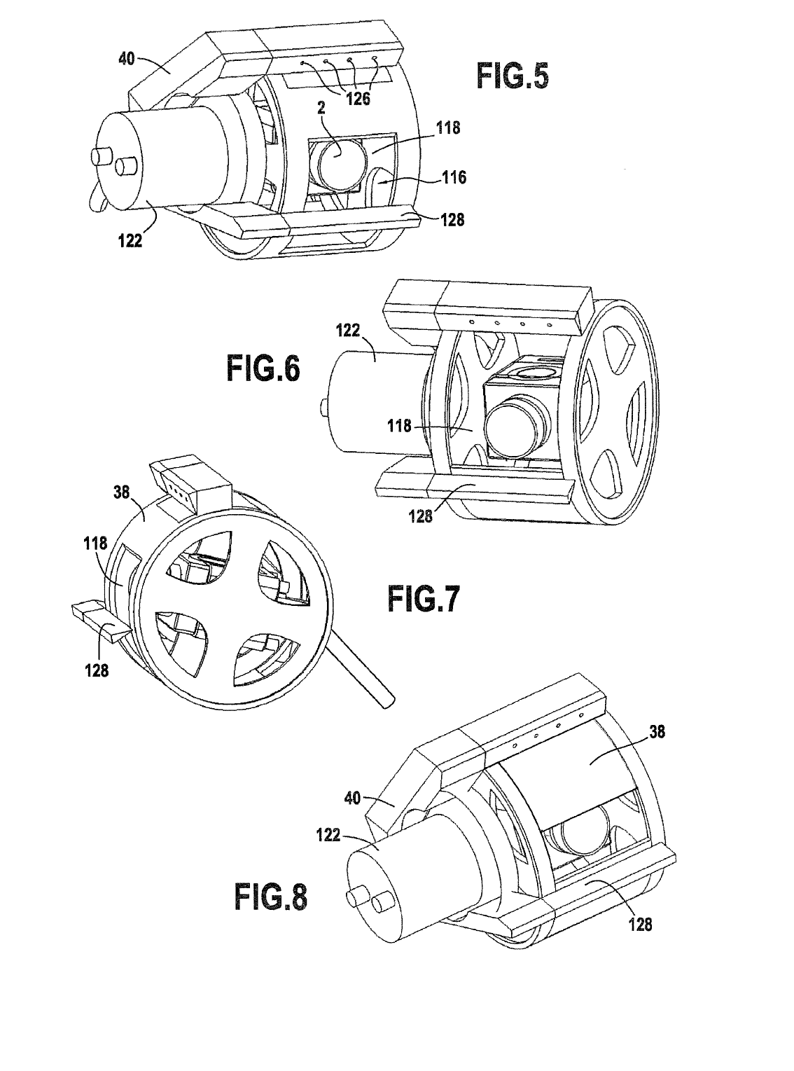

FIGS. 5 to 8 show a second embodiment differing from the first embodiment notably in that the mobile protection element includes an opaque zone (seen in FIGS. 7 and 8 in particular).

An imaging device 1 according to the invention, notably in its application on a motor vehicle, includes, regardless of the embodiment chosen, a video camera 2 for imaging a road scene in the vicinity of the vehicle, a mobile protection element 4 disposed directly in the vicinity of the video camera, around the latter, and adapted to adopt at least two distinct positions by virtue of the effect of the action of drive means 6, and further includes cleaning means 8 the cleaning action of which makes it possible to ensure the sharpness of each image.

The imaging device is installed in a motor vehicle in accordance with the assistance with driving function in which the device participates, i.e. it can be installed on the side of the vehicle, for example, for a side impact detection function or on the front bumper for a pedestrian collision detection function. The imaging device is advantageously installed in the rear part of the vehicle to provide a reversing video camera function, useful in particular for reversing and for assisting with parking. It is this location that is described in detail hereinafter and clearly the orientation of the various elements of the device relative to one another depends on it. In the case of installation toward the front of the vehicle, the various elements would then be in a different orientation without this departing from the scope of the invention.

An imaging device according to a first embodiment, shown in FIGS. 1 to 4, is described first.

The imaging device is installed in the structure of the vehicle set back from a bodywork element 10, for example the rear bumper of the vehicle. An opening 12 is made in the bodywork element to free the field of the video camera and a removable area 14 is formed in the bodywork element around this opening, so that it can be removed from outside the vehicle, with advantages to be described later.

The video camera 2 includes an optical device to acquire images of the road scene, notably a lens disposed at one end of a lens system. The video camera is mounted in a fixed manner relative to the structure of the vehicle, set back from the bodywork element. When fitting the camera, using indexing means, for example, it is ensured that it is oriented correctly so that the lens is disposed in front of the opening 12 in the bodywork element, as shown in FIG. 1.

The mobile protection element 4 takes the form of a circular cylinder and is arranged around the video camera. The mobile protection element is mounted to rotate about a rotation axis perpendicular to the optical axis. The area in front of the lens is defined as an imaging area 16, which remains fixed regardless of the angular position of the protection element as it rotates. The latter element is entirely transparent so that the protection screen may be defined as a series of transparent screens 18 adapted, because of the effect of the rotation of the protection element, to be positioned successively in the imaging area to make it possible to place in front of the video camera a screen for protecting it against dirt which by virtue of its transparency does not impede the acquisition of images by the video camera. In this embodiment, when the device is mounted on the vehicle, the axis of the cylinder forming the mobile protection element extends substantially vertically and parallel to the bodywork element and the cylinder has at least one opening on the bottom for the passage of the fixing means for fixing the video camera to the structural element. The mobile protection element is made entirely from a material transparent to light, for example polycarbonate, of particular benefit here because of its high transparency, important for the quality of imaging, and its impact resistance, important for the protection of the video camera.

The mobile protection element is mounted to be mobile in rotation about the axis of the cylinder and to be driven by the drive means 6. To this end, the mobile protection element includes a toothed ring 20 forming part of gear means. Here the toothed ring is molded in one piece with the mobile protection element. It is on the upper end face of the circular wall of the mobile protection element, facing toward its interior. To guide the rotation of the mobile protection element and to support the weight of said elements, here the cylinder is mounted on an annular guide formed in the structural element, not visible in the figures.

The drive means 6 include a motor 22 and gears 24. The gears include a first gear and a second gear constrained to rotate together, the first gear meshing with a rack disposed at the end of an output shaft of the motor while the second gear meshes with the toothed ring of the mobile protection element, the profile of the teeth of the second gear being complementary to that of the teeth of the ring. The first gear is driven in rotation by the rack when the motor is energized and the resulting rotation of the second gear generates a corresponding rotation of the mobile protection element.

In the embodiment shown, the motor 22 is a non-reversible motor, i.e. it always turns in the same direction. The corresponding rotation of the mobile protection element is always in the same direction.

The whole of the drive means is disposed inside the structure of the vehicle and in line with the mobile protection element, i.e. within the overall height of said protection element and the video camera. Clearly this can facilitate the integration of the device into the structure of the vehicle but to adapt to the structure of any particular vehicle a different position of the drive means relative to the mobile protection element could be adopted, for example by orienting the toothed ring toward the outside and disposing the drive means to one side. This could further make it possible to provide a mobile protection element having an upper transverse wall that covers the cylinder to protect the video camera even more.

The cleaning means 8 are mounted on the structure of the vehicle, here on the internal face of the bodywork element 10, so as to be at a fixed position relative to the rotary movement of the mobile protection element. Here they include a sprayer element 26 and a wiper element 28.

The sprayer element 26 includes a liquid ejector head 30 and an end-piece 32 for feeding cleaning liquid. The sprayer element is arranged to be able, when the mobile protection element passes it, to spray water onto a cleaning area 34 defined on the upstream side relative to the direction of rotation of the mobile protection element of the imaging area 16. The fact that the cleaning area is upstream of the imaging area relative to the direction of rotation of the mobile protection element means that for a given point on the cylinder of the mobile protection element, as the latter rotates, said point first moves into the cleaning zone and then into the imaging zone. Clearly the cleaning zone is fixed whatever the position of the mobile protection element and that in this cleaning zone different parts of the cylinder of the mobile protection element are therefore sprayed as that element passes through it.

The wiper element 28 is disposed between the cleaning zone and the imaging zone. It includes a rubber blade a lip of which is positioned on the generatrix of the cylinder forming the mobile protection element so as to be in contact with the circular wall of the cylinder throughout its rotation. As just described, the wiper element is therefore positioned permanently downstream of the sprayer element relative to the direction of rotation of the mobile protection element.

The operation of the device according to the first embodiment as just described next starting from an initial state in which the device is in an active imaging position. The mobile protection element includes a transparent screen downstream of the lens on the optical axis, i.e. in the imaging field, the transparency to light of said screen enabling imaging without interference. The device as a whole remains in position both during imaging and when imaging is finished. To this end the control module issues a time-delay instruction in regard to the rotation of the mobile protection element.

The protection element is caused to move when a new imaging action is detected. The aim is then, prior to executing the image acquisition function, to execute a cleaning function so that the part of the mobile element moved into the imaging area, i.e. in front of the lens, after this rotation is cleaned and does not degrade the quality of the images acquired.

There is arbitrarily chosen a mode of operation with a rotation of 90° of the protection element to go from an initial imaging position to a subsequent imaging position. To illustrate this idea there are referenced in FIG. 3 four parts regularly dividing the mobile protection element. The first part 36a in the figure is in the imaging zone and the second part 36b, the third part 36c and the fourth part 36d follow on in succession in the direction of rotation of the mobile protection element.

On going to the next imaging position, the fourth part 36d moves into the imaging zone, first passing through the cleaning zone situated on the latter's upstream side relative to the direction of rotation. During this time, each part advances by one quarter-turn toward the imaging zone, the first part 36a that was in front of the lens in the initial position remaining dirty until it returns to the cleaning zone.

The cleaning function consists mainly in sending an instruction to the sprayer element to eject water in the cleaning zone. The sprayed part of the mobile protection element continues to turn until it is positioned in front of the lens in the imaging zone. As it passes, the mobile protection element is wiped by contact of the wiper element against the wall of the cylinder, which removes from the circular wall both water and dirt.

It is clear here that when a cleaning function is triggered before imaging the mobile protection element rotates to bring a new transparent part in front of the lens. A part of the mobile protection element set back behind the bodywork element is driven in rotation into a position in the imaging zone. When this part enters the cleaning zone before this, water is ejected by the sprayer and the wiper downstream of the latter removes the water and dirt.

Automatic cleaning cycles or manual cleaning cycles may be used, and these two types of cycle may be combined. After a certain number of cleaning cycles it is possible to remove the removable part of the bodywork element from outside the vehicle to obtain access to the wiper element that is fixed to it. The latter can therefore be replaced to maintain an optimum cleaning quality during subsequent cycles.

An imaging device according to a second embodiment shown in FIGS. 5 to 8 is described next and includes as described above a video camera 2, a mobile protection element 4, guide means 6 and cleaning means 8. Clearly the following description of this second embodiment uses the same numerical references for similar elements and adds 100 to the reference used for the corresponding element in the first embodiment.

Here the imaging device differs from what has been described above, in particular structurally at the level of the drive means, the mobile protection element and the cleaning means, but also differs functionally in that the cleaning function is triggered after imaging.

The mobile protection element is also a cylinder that in this embodiment has transverse end walls one of which carries a direct drive shaft connecting the motor 122 and the mobile protection element. Here the cylinder is arranged so that in the assembled configuration of the device the axis of the cylinder is substantially horizontal and parallel to the bodywork element.

The circular wall of the cylinder is not made entirely of transparent material but instead includes two distinct parts, namely an opaque screen 38 and a screen 118 that is transparent to light arranged successively on the circular wall in the direction of rotation of the mobile protection element. Accordingly, in the imaging zone 116 in front of the lens, as the mobile protection element moves, there may be an opaque part, for esthetic reasons when imaging is not required, or a transparent part if to the contrary imaging of the road scene is required. Clearly the video camera is protected from dirt both by the opaque part and by the transparent screen of the mobile protection screen.

The cleaning means include a casing 40 for fixing the sprayer element 126 and the wiper element 128 carried by a respective arm parallel to the rotation axis of the cylinder.

The wiper element is unchanged, i.e. it consists in a wiper blade the lip of which is disposed on the generatrix of the cylinder.

Here the sprayer element consists of a plurality of spray nozzles disposed along the corresponding arm, parallel to the rotation axis of the cylinder, the nozzles being oriented so that the liquid that they eject encounters the cylinder in a cleaning zone conforming to what has been described above. Note that according to this second embodiment the cleaning zone coincides with the imaging zone.

Moreover, the cleaning means may include de-icing means on one and/or the other of the arms. To this end a heating element is mounted in the vicinity of the mobile protection element and said heating element can be turned on by a control module as a function of temperature information detected and analyzed by the module.

Here the drive means include only a direct drive motor for the cylinder. They differ additionally from the first embodiment in that the motor is reversible, i.e. able to go from a first extreme position to a second extreme position in a given rotation direction and then to return from the second extreme position to the first extreme position in the opposite rotation direction.

On reading the foregoing description of the structural differences, it is clear that the operation of the imaging device according to the second embodiment differs from the operation described above in that a cleaning function is triggered after imaging, in a cleaning zone that coincides with the imaging zone. There nevertheless results from this a similar operating principle in that cleaning means disposed on the path of a mobile protection element of a video camera make it possible to clean a transparent part of said mobile protection element so that said cleaned transparent part can be placed in front of the video camera, immediately or subsequently, without impeding imaging.

Of course, various modifications can be made to the structures of the imaging device by the person skilled in the art provided that they enable cleaning as just described, the invention notably encompassing all equivalent means and any technically operative combination of said means.

1. A road scene imaging device for a motor vehicle, comprising:
at least one video camera defining an optical axis;
a protection element around the video camera, said protection element being mounted to be mobile in rotation about said video camera and including at least two distinct parts each able to adopt an imaging position in front of the video camera as a result of the effect of the rotation, at least one of the distinct parts being a screen transparent to light disposed in the imaging position when the video camera is operating,
wherein the imaging device includes means for cleaning the transparent screen.

2. The imaging device as claimed in claim 1, wherein the mobile protection element is a cylinder made entirely from a material transparent to light.

3. The imaging device as claimed in claim 2, wherein said cylinder of the mobile protection element is made of polycarbonate.

4. The imaging device as claimed in claim 1, wherein the mobile protection element includes an opaque masking zone in addition to the transparent screen.

5. The imaging device as claimed in claim 1, wherein the protection element is mounted to be mobile in rotation about an axis perpendicular to the optical axis.

6. The imaging device as claimed in claim 1, wherein the means for driving the protection element in rotation include a non-reversible motor.

7. The imaging device as claimed in claim 1, wherein the means for driving the protection element in rotation include a reversible motor driving the protection element in rotation in one direction and then the other between two extreme positions one of which extreme positions corresponds to the imaging position in front of the video camera.

8. The imaging device as claimed in claim 1, wherein the cleaning means are fixed relative to the video camera on the path of the protection element when the protection element moves.

9. The imaging device as claimed in claim 8, wherein the cleaning means comprise:
a sprayer element arranged to spray cleaning liquid onto the transparent screen as the sprayer element passes the screen in a cleaning zone; and
a wiper element for said wiping transparent screen at an exit from said cleaning zone.

10. The imaging device as claimed in claim 9, wherein the sprayer element is upstream of the wiper element relative to the direction of rotation of the mobile protection element.

11. The imaging device as claimed in claim 9, wherein the cleaning means are carried by an additional casing.

12. The imaging device as claimed in claim 11, wherein the sprayer element consists of spray nozzles carried by an arm fastened to the casing that extends parallel to the rotation axis of the cylinder.

13. The imaging device as claimed in claim 9, wherein the cleaning means are mounted on the internal face of a structural element of the vehicle.

14. The imaging device as claimed in claim 13, wherein the wiper element is mounted on a part of the structural element forming a removable area accessible from outside the vehicle.

15. The imaging device as claimed in claim 9, wherein the cleaning means further include at least one heating element in the vicinity of the mobile protection element.

16. The imaging device as claimed in claim 9, wherein the cleaning zone is separate from the imaging zone and in that it is upstream of said imaging zone relative to the rotation direction.

17. The imaging device as claimed in claim 9, wherein the cleaning zone and the imaging zone coincide.

18. A method of aging a road scene in a motor vehicle, comprising:
controlling the rotation of the mobile protection element disposed around an imaging video camera to move into an imaging zone in front of the video camera a part of the protection element forming a transparent screen when an imaging function is required:, and
triggering a cleaning function when the mobile protection element passes through a cleaning zone during said rotation of the protection element.

19. The imaging method as claimed in claim 18, wherein a cleaning function is triggered after imaging.

20. The imaging method as claimed in claim 18, wherein a cleaning function is triggered before imaging.
